(19) United States
(12) Patent Application Publication
(10) Pub. No.: US 2004/0128387 A1
(43) Pub. Date: Jul. 1, 2004

(54) Broadcasting information in ad-hoc network clusters between pseudo-random time intervals

(76) Inventors: Kwan Wu Chin, Dluwich Hill (AU); Raad Raad, Cringila (AU)

Correspondence Address: MOTOROLA, INC., 1303 EAST ALGONQUIN ROAD, IL01/3RD, SCHAUMBURG, IL, 60196

(21) Appl. No.: 10/330,387

(22) Filed: Dec. 27, 2002

(51) Int. Cl. G06F 15/16

(52) U.S. Cl. 709/227; 709/232

(57) ABSTRACT

The invention establishes broadcast channels between neighbor nodes (10) forming ad-hoc clusters of nodes (20). Broadcast channels (25) are established by transmitting (32) a channel establishing request message from the requesting node to inform neighbor nodes of a broadcast channel of said requesting node. The channel establishing request message includes broadcast timing information of the requesting node. Later, the requesting node starts receiving (33) an acknowledge decision message from a said neighbor node to inform the requesting node of a broadcast channel of said neighbor node. The channel acknowledge decision message includes broadcast timing information of the neighbor node. All timing information should have been passed between two or more nodes 10 in the network 20. Accordingly, broadcasting and receiving can be conducted between pseudo-random time intervals that are dependent on the broadcast timing information.

### FIELD OF THE INVENTION

This invention relates broadcasting information in ad-hoc network clusters between pseudo-random time intervals. The invention is particularly useful for, but not necessarily limited to, broadcasting information between wireless sensor platforms in ad-hoc clusters typically used for environmental or ambient data collection.

### BACKGROUND ART

Battery powered wireless sensor platforms, or nodes, using a pair-wise communication channel require an energy efficient process for setting up the pair-wise channel. In Richard Binder and Stephen D. Huffman and Itzhak Gurantz and Peter A. Vena (1987) Cross-link Architectures for a Multiple Satellite System, Proceedings of the IEEE, vol 75. No. 1, January 1987., there is outlined the use of a pseudo-random pair-wise communication scheme for low orbit satellites. The channel set up process uses a master and slave model. The model involves the use of an invite message transmitted through an omni-directional antenna and interested satellites (nodes) in the vicinity reply to the invite message. Each invite message contains sender's identifier, current position and motion, local clock time, and an initialization seed that is sent on a dedicated establishing channel.

Most wireless sensor platforms, forming ad-hoc clusters, typically operate in exposed environments and power is provided by non-renewable energy such as a battery. The use of batteries ensures that the sensor platforms are relatively cheap and disposable. However, due to their sheer numbers, manually replacing power sources (e.g., batteries) may be infeasible. In this respect energy efficient communications protocols must be used in order to prolong the operational lifetime of the sensor platforms. Typically, transceivers of the platforms power up at known rendezvous and thereafter power down to thereby save power.

If pair-wise hopping provides communication between sensor platforms in a cluster, then a data packet would typically have to be transmitted individually to each neighboring sensor platform in the cluster. This means each neighboring sensor platform receives specific information in the data packet at different times. Unfortunately, if the platforms have long time periods before their rendezvous times, then the specific information contained within the data packet could to be out of date before it is received by relevant platforms in the cluster.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for establishing broadcast channels between neighbor nodes forming at least part of a cluster of nodes, the method comprising:

(i) Transmitting a channel establishing request message from the requesting node to inform at least one neighbor node of a broadcast channel of said requesting node, the channel establishing request message including broadcast timing information of the requesting node;

(ii) Receiving an acknowledge decision message from at least one said neighbor node to inform said requesting node of a broadcast channel of said neighbor node, the channel acknowledge decision message including broadcast timing information of the neighbor node;

(iii) Broadcasting information, on said broadcast channel of said requesting node, between pseudo-random time intervals that are dependent on said broadcast timing information of the requesting node; and

(iv) Receiving information, on said broadcast channel of said neighbor node, between pseudo-random time intervals that are dependent on said broadcast timing information of the neighbor node.

Suitably, the method is further characterized by said (i) transmitting step transmitting establishment rendezvous timing information and said (ii) receiving step being effected during at least one time period associated with said establishment rendezvous timing information.

Suitably, the method is further characterized by said (i) transmitting step transmitting establishment rendezvous timing information indicative of when said requesting node will continue to effect said establishing said broadcasting channels.

Preferably, a set of known timing establishment information of neighbor nodes that have communicated with the requesting node is communicated from said requesting node to said acknowledge node during said (i) transmitting step, the set of known timing establishment information indicating when a said neighbor nodes will be attempting to establish said broadcasting channels. In one alternative preferable process, a set of known timing establishment information of neighbor nodes that have communicated with the requesting node is communicated from said requesting node to said acknowledge node during said (ii) receiving step, the set of known timing establishment information indicating when a said neighbor nodes will be attempting to establish broadcasting channels.

Preferably, the set of known timing establishment information is a set of seeds.

Suitably, said broadcast timing information of the requesting node is at last one broadcast seed.

Suitably, said broadcast timing information of the neighbor node is at last one broadcast seed.

Preferably, the channel establishing request message also includes an average channel rendezvous period of the requesting node.

Suitably, the acknowledge decision message also includes an average channel rendezvous period of the neighbor node.

Preferably, the step of listening is only effected if the average broadcast rendezvous period of the neighbor node is acceptable to the requesting node.

According to another aspect of the invention there is provided a wireless sensor platform, comprising:

a wireless transceiver; and

a processor operatively coupled to the wireless transceiver, wherein in use the sensor platform establishes broadcasting channels by transmitting a channel establishing request message to inform at least one neighbor node of a broadcast channel of said platform, the channel establishing request message including broadcast timing information of the platform; and receiving an acknowledge decision message from at least one said neighbor node to inform said platform of a broadcast channel of said neighbor node, the channel acknowledge decision message including broadcast timing information of the neighbor node.

Preferably, in use, the platform also effects broadcasting information, on said broadcast channel of said platform, between pseudo-random time intervals that are dependent on said broadcast timing information of the platform. The wireless sensor platform also preferably effects receiving information, on said broadcast channel of said neighbor node, between pseudo-random time intervals that are dependent on said broadcast timing information of the neighbor node.

Suitably, the wireless sensor platform has a high duty cycle section coupled to a low duty cycle section, wherein low duty cycle section includes the processor and transceiver.

Preferably, the high duty cycle section includes a sensor.

The high duty section may also suitably include a sampler coupled to the sensor.

Preferably, said broadcast information is at least one broadcast seed.

According to another aspect of the invention there is provided an ad-hoc network of nodes comprising at least one requesting node and at least one neighbor node, the nodes communicating by the requesting node effecting:

(x) Broadcasting information, on a broadcast channel of said requesting node, between pseudo-random time intervals that are dependent on broadcast timing information of the requesting node; and

(xi) Receiving information from the neighbor node, on a broadcast channel of said neighbor node, between pseudo-random time intervals that are dependent on broadcast timing information of the neighbor node.

Preferably, the broadcast timing information of the requesting node is communicated from the requesting node to the neighbor node by a prior step of transmitting a channel establishing request message from the requesting node to inform the neighbor node of the broadcast channel of said requesting node, the channel establishing request message including the broadcast timing information of the requesting node.

Suitably, the broadcast timing information of the neighbor node is communicated from the neighbor node to the requesting node by a prior step of receiving an acknowledge decision message from the neighbor node to inform said requesting node of the broadcast channel of said neighbor node, the channel acknowledge decision message including the broadcast timing information of the neighbor node.

Suitably, said broadcast timing information of the requesting node is at last one broadcast seed.

Suitably, said broadcast timing information of the neighbor node is at last one broadcast seed.

Preferably, the channel establishing request message also includes an average channel rendezvous period of the requesting node.

Suitably, the acknowledge decision message also includes an average broadcast rendezvous period of the neighbor node.

Preferably, the step of listening is only effected if the average broadcast rendezvous period of the neighbor node is acceptable to the requesting node.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a schematic diagram of a wireless sensor platform in accordance with the invention;

FIG. 2 is a schematic diagram of a cluster of nodes in the form of the wireless sensor platforms of FIG. 1;

FIG. 3 is a flow diagram illustrating a method for a requesting node establishing a broadcasting communication channel with other nodes in the cluster of nodes of FIG. 2;

FIG. 4 is a flow diagram illustrating a method for an acknowledge node establishing a communication channel with a requesting node in the cluster of nodes of FIG. 2; and

FIG. 5 is state diagram illustrating a method for a wireless sensor platform of FIG. 1 broadcasting information and receiving information.

### DETAILED DESCRIPTION OF THE PREFERRED EMBODIMENT OF THE INVENTION

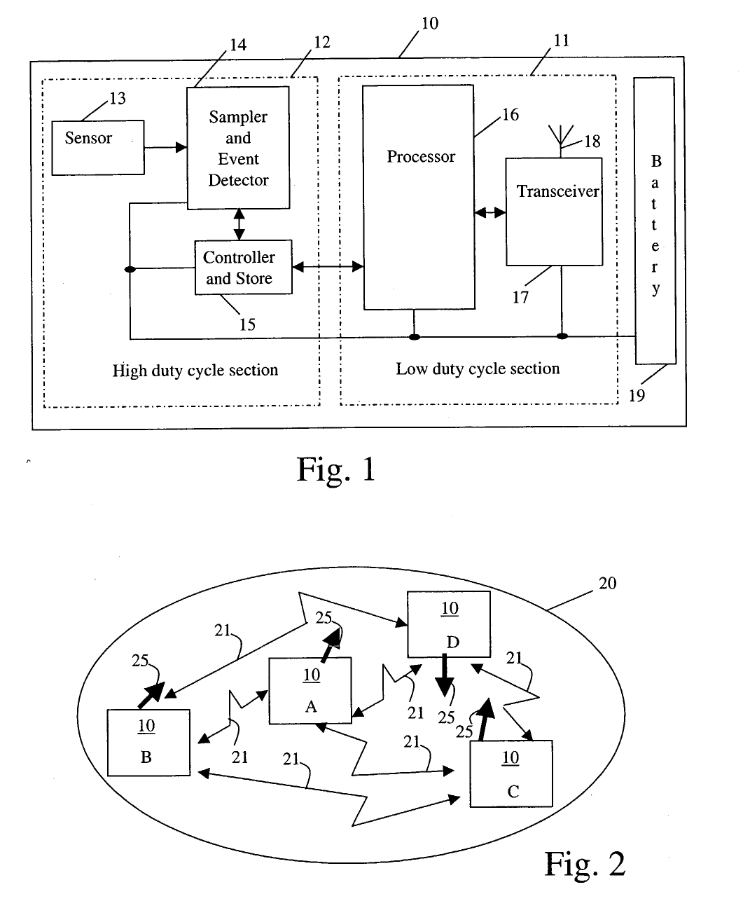

In the drawings, like numerals on different Figs are used to indicate like elements throughout. With reference to FIG. 1 there is illustrated a schematic diagram of a wireless sensor platform 10 comprising a low duty cycle section 11 coupled to a high duty cycle section 12 and a battery 19 is coupled to provide power to both sections 11,12. The high duty cycle section 12 includes a sensor 13 for sensing, amongst others, values of light, pressure, volume, humidity, temperature, wind speed or fluid levels. As shown, sensor 13 is a passive sensor that does not require battery power, however, sensor 13 may also be an active sensor requiring battery power from battery 19. An output from sensor 13 is operatively coupled to a sampler and event detector 14 that is operatively coupled to a controller and store 15.

The low duty cycle section 11 includes a processor 16 operatively coupled to a wireless transceiver 17 that has an antenna 18 for broadcasting radio signals. The processor 16 is operatively coupled to the controller and store 15 thereby providing the coupling of the low duty cycle section 11 to the high duty cycle section 12

With reference to FIG. 2 there is illustrated a schematic diagram of an ad-hoc cluster of nodes 20 comprising wireless sensor platforms 10 each being identified as one of nodes A,B,C,D. The nodes A,B,C,D can preferably communicate using a pair-wise communication protocol through respective pair-wise channels 21. Each of the channels 21 has at least two channel parameters (CP), these channel parameters CP are an average channel duty cycle known as a channel mean rendezvous period (CMRP) and a seed (SD). Using these two channel parameters (CP), and an initial time reference (TR), a pair of nodes in the cluster 20 only power up their respective low duty cycle section 11 at rendezvous times (RT) in order to exchange data by pair-wise communication. Also, the nodes communicate via. broadcast channels 25, that broadcast information between neighbor nodes, the information being broadcast between pseudo-random time intervals (PRTI).

The rendezvous times RT are determined using a pseudo-random generator, programmed into the processor 16 of each platform 10, hence, any two wireless sensor platforms 10 sharing a seed SD can calculate a rendezvous time RT for communication. By knowing the rendezvous times RT, a wireless sensor platform 10 is able to determine each channel mean rendezvous period CMRP (including the mean rendezvous times for the broadcast channels). Accordingly, from all the channel mean rendezvous period CMRPs associated with the platform 10, a platform or node total mean rendezvous period TMRP can be determined and monitored to limit the platforms 10 overall duty cycle.

The rendezvous times RT are determined by shared information typically in the form of a shared seed SD that is exchanged (communicated) during channel set up between a wireless sensor platform pair. After exchanging (communicating) the shared seed SD, the wireless sensor platform pair calculate the rendezvous times RT at which both of them will be awake for receiving or transmitting (powering up their respective low duty cycle section 11). In this regard, the low duty cycle section 11, when sleeping, will typically be operating in a low power mode with the transceiver 18 powered down. However, the processor 16 will be operating on low power mode and performs functions such as monitoring time to effect wake up of the low duty cycle section 11 when, for instance, a rendezvous time (RT) or a pair-wise communication channel establishing is scheduled as described below.

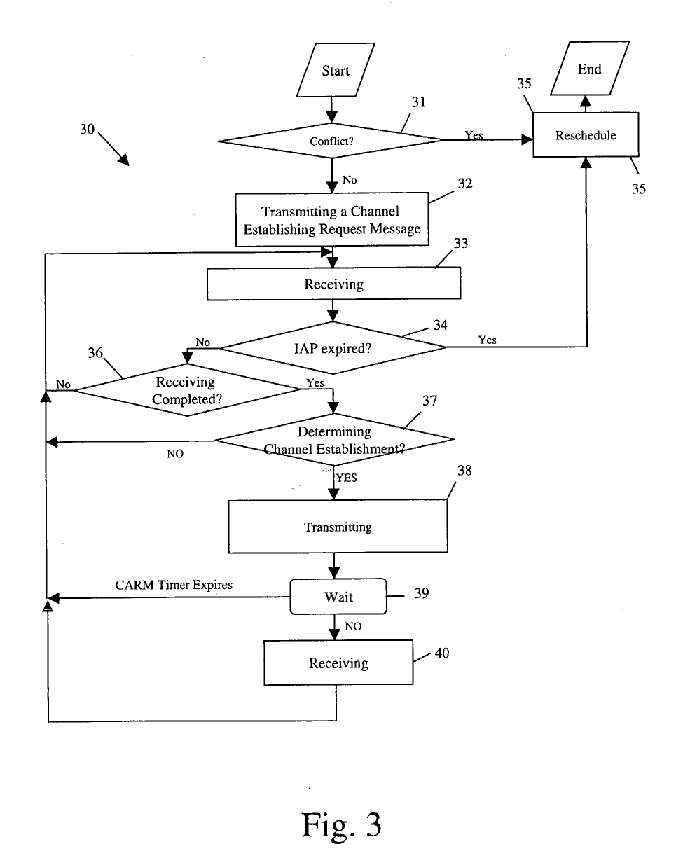

With reference to FIG. 3, there is illustrated a method 30 for a requesting node, for instance node A, establishing a pair-wise communication channel with another node (a neighbor node), for instance one of neighbor nodes B, C, D, where the nodes are typically the wireless sensor platforms 10 in network 20. The method 30 also provides for establishing broadcast channels between neighbor nodes B,C,D forming at least part of a cluster of nodes 20.

The method 30 includes a conflict check 31 to determine if there are any potential conflicts that may occur if the requesting node A effects a transmitting a channel establishing request message. During the conflict check 31, a conflict check is performed to ensure that a channel rendezvous time RT or broadcasting time is not coincident with processing times associated with the method 30 attempting to establish a channel and thus a communication would be in progress with the requesting node A. The conflict check 31 also tests a variable NO_IM_FLAG that determines whether a channel establishing request signal needs to be transmitted at all.

Typical reasons when the channel-establishing signal doesn't need to be transmitted are when a maximum number of pair-wise channels have already been established or because of higher layer admission control policies. The conflict check 31 also tests the number of channels that have been established and thus a conflict occurs when the maximum number is reached. If a conflict is determined then a reschedule step 35 is effected and the method 30 ends and may be invoked again at a later time. It should be noted that the value of the variable NO_IM_FLAG may be modified (for example due to a change in the state of the ad-hoc cluster of nodes 20) before the method 30 is invoked again.

After the conflict check 31, there is a step 32 of transmitting a channel establishing request message from the requesting node A to inform at least one neighbor node of a broadcast channel of the requesting node A. The channel establishing request message includes broadcast timing information of the requesting node. Hence, the requesting node A constructs the request message or invite message (IM). The IM consist of the following fields: requesting node identifier, packet type (set to IM_PACKET type), the time reference TR, broadcast seed (S1), requested channel mean rendezvous period RCMRP, and an Invite Awake Period (IAP). The packet type is a header indicating that the IM is an invite message. The time reference TR is provided as each node A,B,C,D in the cluster 20 needs a time base reference in order to power up their low duty cycle section 11 at times, for instance, identified by the Invite Awake Period IAP. Furthermore, the broadcast seed is used for a pseudo-random number generator inherent in the processor 16 and the broadcast seed is essentially broadcast timing information.

The Invite Awake Period IAP informs potential acknowledge nodes B, C, D of the time period at which channel establishment is possible with the requesting node A. In other words the Invite Awake Period IAP provides for the step 32 to transmit establishment rendezvous timing information. The Invite Awake Period IAP can also be used in the step 32 to provide for transmitting establishment rendezvous timing information indicative of when the requesting node will continue to effect (repeat) the establishing a pair-wise communication channel (e.g. when method 30 will be repeated). Three preferred methods to determine the Invite Awake Period IAP are as follows:

(a) The first method (IAP-1) is to set IAP manually, i.e., a fixed time value determined at time of deployment of the requesting node A. This means during an establishing of a pair-wise communication channel, a potential acknowledge node B,C,D receiving a channel establishing request message knows the exact duration at which the requesting node A will remain awake (the low duty cycle section 11 will be activated) to establish a pair-wise communication channel. Alternatively, a fixed value can be chosen at random or depending on the duty cycle of the requesting node A or congestion experience by the requesting node A. As will be explained later, potential acknowledge nodes B,C,D respond to the requesting node A by setting a random back-off timer to reduce any competing or contention problems with other acknowledge nodes when sending an acknowledge decision message to the requesting node. The random back-off timer is used to minimize collisions of responses due to the received of invite message. By using a back-off timer, each node will probably respond at a different time therefore increasing the probability of getting their response through.

(b) The second method (IAP-2) requires the requesting node A to inform potential acknowledge nodes C,D,E of channel establishment rendezvous times by informing them of a set of invitational seeds that they can use to calculate the time at which the requesting node is awake to receive the acknowledge decision message. The channel establishing request message contains a set or list of the requesting node's A invitational seeds and possibly seeds from its neighboring nodes in the cluster 20 that have already established (or attempted to establish) pair-wise communication with the requesting node. Thus the set of seeds (generally referred to as known timing establishment information) can include seeds from neighbor nodes.

The set or list of invitational seeds serves two purposes. First, the seeds enable acknowledge nodes to determine a time period at which channel set up is performed by the requesting node. Second, the list indicates to potential acknowledge nodes other possible requesting nodes and their channel set up time. Given that an acknowledge node knows the invitational seeds of requesting nodes, the acknowledge node's low duty cycle section 11 does not have to remain active (powered up) for a long period of time looking for possible pair-wise communication channels.

(c) The third method (IAP-3) consists of informing potential acknowledge nodes B,C,D of a predefined number of time slots when the requesting node A will be listening. Potential acknowledge nodes that receive the channel establishing request message choose one of the advertised slots randomly to transmit an acknowledgement message to the requesting node A. The low duty cycle section 11 of the requesting node A is active (powered up) for a short period of time at the start of each slot to determine whether an acknowledgement message is sent by an acknowledge node. If none is received, the requesting node A powers down its low duty cycle section 11. By only remaining awake for a short period of time, the requesting node A can avoid remaining awake when there are no nodes interested in channel establishment. Otherwise if an acknowledgement message is received the requesting node A proceeds with the channel establishment.

After calculating the IAP, step 32 fills in all the required fields in the invite message IM and effects the transmitting of a channel establishing request message.

After step 32, the method 30 at step 33 starts receiving a acknowledge decision message from an acknowledge node (one of nodes B,C,D) to inform the requesting node A of a broadcast channel of the neighbor node. The channel acknowledge decision message includes broadcast timing information of the neighbor node this acknowledge message includes at least one pair-wise communication channel requirement. If the requesting node A is unable to receive any acknowledge decision message within the IAP determined by a test 34, method 30 goes to the reschedule step 35 where another IM is scheduled using the chosen IAP calculation method and the method 30 ends. The acknowledge decision message is a Channel Request Message CRM comprising the following: the acknowledge node's identifier; packet type (CRM_PACKET type); time reference; broadcast seed (S2); transmission seed and an associated transmission channel mean rendezvous period CMRP; and receiving seed and associated receiving channel mean rendezvous period CMRP. As will be apparent to a person skilled in the art, the transmission seed is shared information associated with when the acknowledge node wishes to transmit to the requesting node and the receiving seed is shared information associated with when the acknowledge node wishes to be in receiving mode for receiving messages transmitted from the requesting node. As above, the broadcast seed is used for a pseudo-random number generator inherent in the processor 16 and the broadcast seed is essentially broadcast timing information.

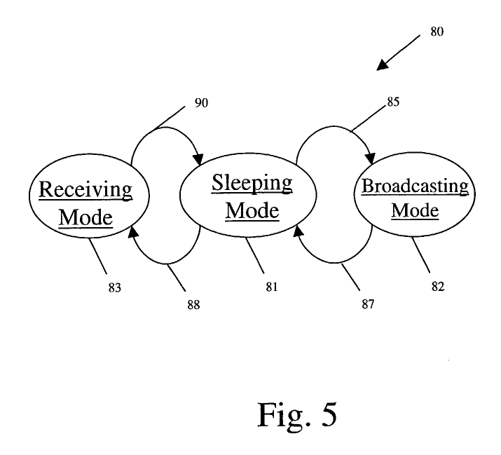

After the step of receiving 33 is completed, determined by a test 36, the method 30 transitions to a determining channel establishment step 37 for determining a request decision message indicating if a channel is to be established with the acknowledge node. At this point it should be noted that the method 30 should have provided all information necessary to establish broadcast channels. Accordingly, broadcasting is effected with reference to FIG. 5, however, method 30 in this embodiment continues to establish pair-wise communication.

The request decision message indicates acceptance of the establishing acknowledge message if the requirement is acceptable to the requesting node A. The requirement is acceptable if it meets a number of conditions determined by the requesting node. A first condition is based on whether the transmission channel mean rendezvous CMRP plus the receiving channel mean rendezvous CMRP, when summed with the current total mean rendezvous period TMRP of the requesting node (the sum of all transmission CMRP and receiving CMRPs currently allocated to the requesting node), does not exceed a threshold mean rendezvous period value. It should be noted that although mean is the preferred average calculation value, other calculations indicative of average rendezvous periods can be used. Accordingly, mean and average are used interchangeably throughout this specification. The transmission CMRP and receiving CMRP are each therefore a requested average rendezvous period from the acknowledge node. Further, the threshold mean rendezvous period value is based on a maximum duty cycle limit MAX_DC.

Duty cycle is defined as the workload (e.g., energy consumed per transmission/reception) incurred processing the transmission and reception from the given acknowledge node. However, if the threshold mean rendezvous period value will be exceeded if the requested average rendezvous periods (transmission CMRP and receiving CMRP) are accepted then the requesting node can select one or both alternative acceptable average rendezvous periods (transmission CMRP and/or receiving CMRP). The acceptable average rendezvous periods are longer than the requested average rendezvous period therefore allowing the first condition to be met.

A second condition is based on whether or not a channel already exists for pair-wise communication with the acknowledge node. A third condition is whether or not the maximum number of channels has been established. A fourth condition is whether or not the network layer, or any higher communications layer, is indicating to method 30 to still seek more channels. As will be apparent to a person skilled in the art, the term network layer refers to any routing protocol used by the sensor nodes to get their data to another node. If the maximum number of channels has been reached then the variable NO_IM_FLAG is set resulting in stopping the requesting node from transmitting a further IM until such time an existing acknowledge node becomes unavailable. Once all the above conditions are met an accept decision is written into the decision message or channel status message (CSM), whereby the decision message may include the acceptable average rendezvous periods. Otherwise a reject decision is written to the channel status message CSM.

If the determining 37 determines the channel should not be established the method 30 returns to the receiving step 33. Alternatively, if the determining 37 determines the channel should be established then the requesting node A starts transmitting the decision message to the acknowledge node, at step 38, thereby confirming establishment of the pair-wise communication channel between the requesting node and the acknowledge node at communication rendezvous times based on shared information communicated between the requesting node and the acknowledge node. At this stage, the requesting node A, at an optional waiting step 39, invokes a timer called channel accept reject message (CARM) timer that determines the expected time at which a confirmation acknowledge message sent by the acknowledge node should arrive. If the CARM timer expires without the requesting node A receiving a confirmation acknowledge message, then the requesting node A returns to step 33. However, if the CARM timer does not expire and the requesting node A starts receiving the confirmation acknowledge message, from the acknowledge node, then an optional receiving step 40 effects a receiving a confirmation acknowledge message from the acknowledge node in response to the step 38 of transmitting said decision confirming receipt of the request decision message by the acknowledge node.

After the receiving step 40 the confirmation acknowledge message from the acknowledge node at step 40, method 30 returns to the step 33 where it waits for further acknowledgement messages from other acknowledge nodes. It should be noted that steps 32 to 40 are preferably effected during a time associated with the establishment rendezvous timing information, hence there is an inherent wait period within or after step 32.

The shared information referred to in step 38 includes at least one shared seed (SS). Typically the shared seed SS includes the transmission seed and receiving seed comprising part of the acknowledge decision message received during step 33. However, the shared seed SS can be communicated from the requesting node to the acknowledge node during the transmitting step 38 or the shared seed SS could be communicated in the transmitting step 32. Another alternative is that the shared seed SS could be communicated in the receiving step 40.

Further, time intervals between commencement of consecutive ones of the communication rendezvous times may vary pseudo-randomly as the shared seed can be used by a pseudo random number generator, inherent in each platform's processor 16, to determine commencement of pair-wise communication at varying time intervals. Also, referring back to step 32, the IAP is typically used to identify when the steps 33 to 40 will be effected.

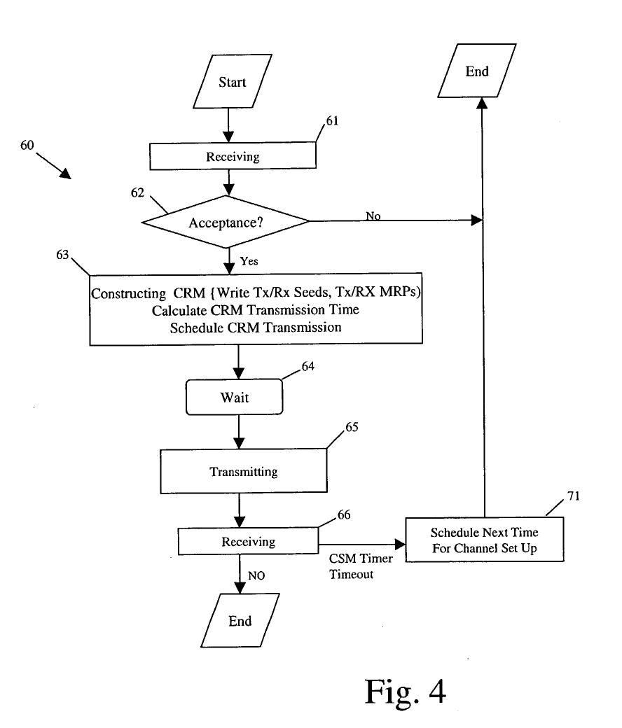

With reference to FIG. 4, there is illustrated a method 60 for one of the potential acknowledge nodes C,D,E establishing a pair-wise communication channel with a requesting node. The method 60, in response to the step of transmitting 32, effects a step 61 of receiving a channel establishing request message from the requesting node A, whereby preferably the receiving node receives the IM. Once the IM from the requesting node A is received the fields within the IM are processed and stored in a temporary memory storage of the processor 16 and information in these fields are used by the acknowledge node to decide whether or not it wants to establish a channel with the requesting node A.

After receiving at step 61, the acknowledge node starts determining an acknowledge decision message indicating if a channel is to be established with the requesting node, the acknowledge decision message indicating acceptance of the channel establishing request message if at least one pre-defined condition is satisfied at step 62. A first condition is whether the acknowledge node already has a channel with this particular requesting node. A second condition is based on whether the requested channel mean rendezvous period RCMRP, when summed with the current total mean rendezvous period TMRP of the acknowledge node (the sum of all transmission CMRP and receiving CMRPs currently allocated to the acknowledge node), does not exceed a threshold mean rendezvous period value stored in the variable MAX_DC of the acknowledge node. If the decision is not to establish a channel, then the method ends. Alternatively, if the decision is to establish a channel then the method 60 determines an appropriate time that an acknowledgement is sent to the requesting node A.

After the decision 62 determines to establish a channel the method 60 proceeds to constructing step 63 where the acknowledge decision message is a Channel Request Message CRM is constructed and a timer is set in accordance with the IAP contained in the Channel establishing message, the IAP being establishment rendezvous timing information. Accordingly, the timer determines the time at which the acknowledge node responds to the requesting node, in other words the timer determines when the rest of the steps of method 60 will be effected. This timer is governed by the IAP method employed by the requesting node since the IAP method determines the time at which the requesting node is ready to receive an acknowledgement message. To determine the value of the timer at which a response is to be sent, the following conditions are used with reference to the previously outlined IAP calculation methods chosen by the requesting node A.

(a) The acknowledge node chooses a back-off timer that expires within a fixed time interval and when the back-off timer expires the acknowledge node transmits the acknowledge decision message. The back-off time serves to minimize collisions from other acknowledge nodes by randomizing the channel access process.

(b) Given that the IM message contains a set of seeds of the requesting node A and also from the requesting node's neighbors the acknowledge node is able to determine the number of neighboring nodes that it does not have rendezvous times with. Further, the acknowledge node is able to determine the wake-up times of those nodes. Choosing a random seed from the IM of the requesting node A, the acknowledge node calculates the time at which the requesting node will be awake (when the low duty cycle section 11 is activated) to perform channel set up. Once the channel set up time is calculated the acknowledge node's low duty cycle section 11 powers down. In addition using the seeds of neighboring nodes advertised by the requesting node, the acknowledge node may set up additional timers to coincide with other requesting nodes to set up channel establishment.

(c) Acknowledge nodes that receive the invite message choose a slot randomly from the advertised slots in the invite message when responding to the requesting node.

The acknowledge node then proceeds to step 64 where it waits for the appropriate timer to expire. The timer here is dependent on the aforementioned IAP methods. In IAP-1, the timer would be a back-off timer. In IAP-2, the timer is derived from the advertised seed within the IM. In IAP-3, a random slot is chosen from those advertised in the IM and the acknowledge node waits for the arrival of the slot time.

Upon the expiry of the timer at step 64, the acknowledge node starts transmitting 65 the acknowledge decision message (by transmitting the CRM) and starts another timer called channel-status-message (CSM) timer. The channel-status-message CSM timer indicates the period by which the acknowledge node waits for a confirmation in the form of a request decision message from the requesting node A.

After method 60 has transmitted the CRM at step 65, there is a step 66 of receiving a request decision message from the requesting node A in response to the transmitting the decision step 65 transmitting the decision message indicating the acceptance. This step 66 thereby confirming establishment of said pair-wise communication channel between said requesting node and said acknowledge node at communication rendezvous times based on shared information communicated between said requesting node and said acknowledge node.

If the request decision message is received before the expiry of the CSM timer then step 66 inherently effects confirming establishment of the pair-wise communication channel between the requesting node A and the acknowledge node at communication rendezvous times based on shared information communicated between said requesting node and said acknowledge node. The method then ends. Otherwise, method 60 reschedules the reception of the IM at schedule step 71 and then ends.

The shared information referred to in step 66 includes at least one shared seed (SS). Typically the shared seed SS includes the transmission seed and receiving seed comprising part of the acknowledge decision message (the CRM) transmitted during step 65. However, the shared seed SS can be communicated from the requesting node to the acknowledge node during the receiving step 61 or the shared seed SS could be communicated in the receiving step 66.

At the schedule step 71, the acknowledge node determines the next wake up time at which it will wake up to negotiate a channel with a requesting node. The next wake up time for method 60 depends on the IAP calculation used by the requesting node A. The following describes the action taken with regards to each IAP methods:

(a) For the IAP-1 method, a fixed time period is used and this timing information is included in the IM. The requesting node then works out the next time interval that the requesting node will be awake to perform channel set up.

(b) For the IAP-2 method, a seed was used to determine the channel set up rendezvous time with the requesting node, therefore the same seed is used to determine the next rendezvous time and the acknowledge node power-ups at that time and try to receive an IM from the requesting node and performs channel set up.

(c) For the IAP-3 method, the acknowledge node chooses another random slot advertised by the requesting node. If there are no slots remaining in the current cycle of channel set up the acknowledge node waits for the start of the next cycle of slots from the requesting node.

It should be noted that steps 62 to 67 are preferably effected during a time associated with the establishment rendezvous timing information, hence there is an inherent wait period within or after step 62.

Further, time intervals between commencement of the communication rendezvous times may vary as the shared seed can be used by a pseudo random number generator, inherent in each platform's processor 16, to determine commencement of pair-wise communication at varying time intervals.

Referring to FIG. 5 there is state diagram 80 illustrating a method for a wireless sensor platform 10 broadcasting information and receiving information. When in sleeping mode 81 the low duty cycle section 11 is in low power mode. Assuming that the method 30 is completed, and therefore the broadcast timing information is stored in a memory of the processor 16, then the following is a typical method operation for the wireless sensor platform 10. The wireless sensor platform 10 monitors an internal clock in the processor 16 during sleeping mode 81 and transitions 85 to a broadcasting mode 82 when the internal clock reaches a pseudo-random time interval that is dependent upon the broadcast seed S1. The broadcast seed S1 is the broadcast timing information of the requesting node (platform 10) contained in its invite message IM. More specifically, in this preferred embodiment, the pseudo-random time interval is determined by the broadcast seed S1 and an associated pseudo-random generator in processor 16.

When in broadcasting mode 82 the platform 10 broadcasts information on its broadcast channel. After a short broadcast period the platform transitions 87 to the sleeping mode. If desired, the broadcasting mode 82 can be repeated several times before the sleeping mode 81 transitions 88 to a receiving mode 83 when the internal clock reaches a pseudo-random time interval that is dependent upon the broadcast seed S2. The broadcast seed S2 is the broadcast timing information of a neighbor node contained in its channel request message CRM. More specifically, in this preferred embodiment, the pseudo-random time interval is determined by the broadcast seed S2 and an associated pseudo-random generator in processor 16. When in listening mode 83 the platform 10 receives information on a broadcast channel of a neighbor node. After a short receive period the platform transitions 90 to the sleeping mode 81. If desired, the receiving mode 83 can be repeated several times before the sleeping mode 81 transitions 85 to the broadcasting mode 82.

Advantageously, the present invention provides for establishing broadcast channels communication channels between sensor platforms in ad-hoc clusters. The invention provides for broadcasting information, on the broadcast channel of said requesting node A, between pseudo-random time intervals that are dependent on the broadcast timing information of the requesting node. Also, the invention provides for receiving information, on the broadcast channel of a neighbor node, between pseudo-random time intervals that are dependent on the broadcast timing information of the neighbor node.

The present invention may suitably reduce the probability of sensor platforms attempting to communicate with other platforms when the other platforms are already engaged in communicating (by an established pair-wise communication channel or when communicating to establish such a channel). The invention also allows for the set of seeds (the known timing establishment information) to be communicated between requesting node and the acknowledge node during any of the steps 32,33, 38 or 40. The invention further allows for the set of seeds (the known timing establishment information) to be communicated between requesting node and the acknowledge node during any of the steps 61, 65 or 66. Hence, this allows for battery saving of each node as the known timing establishment information indicates when neighboring nodes will be attempting to establish pair-wise communication. However, it should be apparent to a person skilled in the art that the present invention need not be part of a method for establishing pair-wise communication as described in the preferred embodiment above.

The detailed description provides a preferred exemplary embodiment only, and is not intended to limit the scope, applicability, or configuration of the invention. Rather, the detailed description of the preferred exemplary embodiment provides those skilled in the art with an enabling description for implementing a preferred exemplary embodiment of the invention. It should be understood that various changes might be made in the function and arrangement of elements without departing from the spirit and scope of the invention as set forth in the appended claims.

We claim:

1. A method for establishing broadcast channels between neighbor nodes forming at least part of a cluster of nodes, the method comprising:
(i) Transmitting a channel establishing request message from the requesting node to inform at least one neighbor node of a broadcast channel of said requesting node, the channel establishing request message including broadcast timing information of the requesting node;
(ii) Receiving an acknowledge decision message from at least one said neighbor node to inform said requesting node of a broadcast channel of said neighbor node, the channel acknowledge decision message including broadcast timing information of the neighbor node;
(iii) Broadcasting information, on said broadcast channel of said requesting node, between pseudo-random time intervals that are dependent on said broadcast timing information of the requesting node; and
(iv) Receiving information, on said broadcast channel of said neighbor node, between pseudo-random time intervals that are dependent on said broadcast timing information of the neighbor node.

2. A method, as claimed in claim 1, further characterized by said (i) transmitting step transmitting establishment rendezvous timing information and said (ii) receiving step being effected during at least one time period associated with said establishment rendezvous timing information.

3. A method, as claimed in claim 1, further characterized by said (i) transmitting step transmitting establishment rendezvous timing information indicative of when said requesting node will continue to effect said establishing said broadcasting channels.

4. A method, as claimed in claim 1, wherein a set of known timing establishment information of neighbor nodes that have communicated with the requesting node is communicated from said requesting node to said acknowledge node during said (i) transmitting step, the set of known timing establishment information indicating when a said neighbor nodes will be attempting to establish said broadcasting channels.

5. A method, as claimed in claim 1, wherein a set of known timing establishment information of neighbor nodes that have communicated with the requesting node is communicated from said requesting node to said acknowledge node during said (ii) receiving step, the set of known timing establishment information indicating when a said neighbor nodes will be attempting to establish broadcasting channels.

6. A method, as claimed in claim 4, wherein the set of known timing establishment information is a set of seeds.

7. A method, as claimed in claim 5, wherein the set of known timing establishment information is a set of seeds.

8. A method, as claimed in claim 1, wherein said broadcast timing information of the requesting node is at last one broadcast seed.

9. A method, as claimed in claim 1, wherein said broadcast timing information of the neighbor node is at last one broadcast seed.

10. A method, as claimed in claim 1, wherein the channel establishing request message also includes an average channel rendezvous period of the requesting node.

11. A method, as claimed in claim 10, wherein, the acknowledge decision message also includes an average channel rendezvous period of the neighbor node.

12. A method, as claimed in claim 1, wherein the step of listening is only effected if the average broadcast rendezvous period of the neighbor node is acceptable to the requesting node.

13. A wireless sensor platform, comprising:
a wireless transceiver; and
a processor operatively coupled to the wireless transceiver, wherein in use the sensor platform establishes broadcasting channels by transmitting a channel establishing request message to inform at least one neighbor node of a broadcast channel of said platform, the channel establishing request message including broadcast timing information of the platform; and receiving an acknowledge decision message from at least one said neighbor node to inform said platform of a broadcast channel of said neighbor node, the channel acknowledge decision message including broadcast timing information of the neighbor node.

14. A wireless sensor platform as claimed in claim 13, wherein in use, the platform also effects broadcasting information, on said broadcast channel of said platform, between pseudo-random time intervals that are dependent on said broadcast timing information of the platform.

15. A wireless sensor platform as claimed in claim 13, wherein in use the wireless sensor platform effects receiving information, on said broadcast channel of said neighbor node, between pseudo-random time intervals that are dependent on said broadcast timing information of the neighbor node.

16. A wireless sensor platform as claimed in claim 13, wherein the wireless sensor platform has a high duty cycle section coupled to a low duty cycle section, wherein low duty cycle section includes the processor and transceiver.

17. A wireless sensor platform as claimed in claim 16, wherein the high duty cycle section includes a sensor.

18. A wireless sensor platform as claimed in claim 17, wherein high duty section includes a sampler coupled to the sensor.

19. A wireless sensor platform as claimed in claim 13, wherein said broadcast information is at least one broadcast seed.

20. An ad-hoc network of nodes comprising at least one requesting node and at least one neighbor node, the nodes communicating by the requesting node effecting:
(x) Broadcasting information, on a broadcast channel of said requesting node, between pseudo-random time intervals that are dependent on broadcast timing information of the requesting node; and
(xi) Receiving information from the neighbor node, on a broadcast channel of said neighbor node, between pseudo-random time intervals that are dependent on broadcast timing information of the neighbor node.

21. An ad-hoc network of nodes as claimed in claim 20, wherein the broadcast timing information of the requesting node is communicated from the requesting node to the neighbor node by a prior step of transmitting a channel establishing request message from the requesting node to inform the neighbor node of the broadcast channel of said requesting node, the channel establishing request message including the broadcast timing information of the requesting node.

22. An ad-hoc network of nodes as claimed in claim 20, wherein the broadcast timing information of the neighbor node is communicated from the neighbor node to the requesting node by a prior step of receiving an acknowledge decision message from the neighbor node to inform said requesting node of the broadcast channel of said neighbor node, the channel acknowledge decision message including the broadcast timing information of the neighbor node.

23. An ad-hoc network of nodes as claimed in claim 20, wherein said broadcast timing information of the requesting node is at last one broadcast seed.

24. An ad-hoc network of nodes as claimed in claim 20, wherein said broadcast timing information of the neighbor node is at last one broadcast seed.

25. An ad-hoc network of nodes as claimed in claim 20, wherein the channel establishing request message also includes an average channel rendezvous period of the requesting node.

26. An ad-hoc network of nodes as claimed in claim 20, wherein the acknowledge decision message also includes an average broadcast rendezvous period of the neighbor node.

27. An ad-hoc network of nodes as claimed in claim 26, wherein, the step of listening is only effected if the average broadcast rendezvous period of the neighbor node is acceptable to the requesting node.
